(19) United States
(12) Patent Application Publication
(10) Pub. No.: US 2002/0131919 A1
(43) Pub. Date: Sep. 19, 2002

(54) Modular fuel processing system for plate reforming type units

(76) Inventors: Crispin L. DeBellis, North Canton, OH (US); Timothy A. Fuller, North Canton, OH (US); Milind V. Kantak, Mayfield Heights, OH (US); Thomas J. Flynn, North Canton, OH (US); Stephen W. Scoles, Lynchburg, VA (US)

Correspondence Address: BWX TECHNOLOGIES, INC., 1562 BEESON STREET, ALLIANCE, OH, 44601, US

(21) Appl. No.: 09/808,768

(22) Filed: Mar. 15, 2001

(51) Int. Cl. B01J 8/04

(52) U.S. Cl. 422/188; 422/190; 422/191

(57) ABSTRACT

A modular fuel processing system has component modules stacked together into a single tower or stacked separately in various configurations in other embodiments. A backbone member having all fluid connections for the modules thereon connects the component modules of the stack(s). The backbone member may contain quick disconnect fittings on each module. The modules of the system are preferably configured using plate-type reactors.

This invention was conceived under government contract DE-FC02-99EE50586. The United States government may retain certain rights to this invention.

### BACKGROUND OF THE INVENTION

1. Field of the Invention

The present invention generally relates to systems for converting hydrocarbon fuels to a hydrogen-rich gas stream and more particularly to a unified modular assembly to accomplish such a conversion.

2. Description of the Prior Art

Steam reforming of hydrocarbon fuels is the process of converting hydrocarbon fuels, such as natural gas, gasoline and diesel, into a hydrogen-rich gas (typically containing a mixture of H₂, H₂O, CO and CO₂). In turn, this hydrogen-rich gas may be used in fuel cells for the production of electrical current in fuel cells, along with other known uses. Additionally, further processing of the hydrocarbon fuel feed gas (prior to the actual reforming) or to the hydrogen rich effluent (after the reforming) may be required in order to use the aforementioned hydrogen-rich gas.

The hydrogen-rich effluent produced by the steam reforming process is created via an endothermic reaction. Accordingly, any reforming system must provide a heat source in order to drive the hydrogen producing reaction.

A packed bed reformer is one of the devices that can be used in the steam reforming process. In this packed bed arrangement, heat is provided via a combustion reaction. The combustion reaction occurs in a packed bed of pelletized ceramic material, like alumina, on which a catalyst, usually a precious metal, is applied. The ceramic material is called the catalyst support structure. One drawback to packed beds is that they are usually large and heavy. Furthermore, the large amount of air required to drive the packed bed reaction dilutes the concentration of the outflowing hydrogen-rich gas, thereby increasing the size and weight of downstream equipment.

Another method for sustaining the heat required to drive a reforming reaction involves using a plate-type reactor. The plates in a plate reactor are normally coated with reforming catalyst on one side and a combustion catalyst on the other. The plates are then arranged to form alternating reforming catalyst-coated channels and combustion catalyst-coated channels. Some of the fuel is mixed with air and burned in the combustion channels, thereby generating heat. The heat is generated on the surface of the plate within the catalyst coating. The remaining feed gas is mixed with steam and provided to the reforming channels, which share a common wall (via the catalyst coated plates). The heat from the combustion channels is conducted through the plates and drives the reforming reaction occurring on the surface of the plates in the reforming channel. Once the reforming channels reach the necessary temperature, the feed gas being provided to the reforming channels is reformed into the desired hydrogen-rich gas.

One concern in such reforming processes involves issues of mobility and weight. Experts predict a shift toward a more hydrogen-based economy in the near future. In this situation, hydrogen-rich gases will become the fuel of choice for a wide array of devices, including vehicles, ships, and buildings, so that the ability to reform current, widely available hydrocarbon fuels will increase in importance. As this occurs, the need for light-weight, compact reformer systems which may be adapted for use in a variety of mobile and/or stationary applications will increase.

Another general concern for any reforming process is the additional removal of certain components present in the original hydrocarbon fuel feed gas which may be detrimental to the components of the reforming process itself and/or harmful to the system to which the hydrogen-rich gas is provided. For example, for the efficient operation of a reforming process, it may be advantageous to reduce or eliminate the sulfur content of the feed gas prior to attempting to convert the feed gas to a hydrogen-rich mixture. Likewise, it may be desirable to remove CO prior to supplying the hydrogen-rich effluent to its intended post-reforming use (e.g., as a fuel for a proton exchange fuel cell stack). Clearly, it would be advantageous to provide an entire fuel processing system which readily and easily incorporates a reforming process with these additional processes.

In particular, most known fuel processor systems require integration of the reformer with a series of heat exchangers and/or catalytic reactors in order to maximize the hydrogen content and to minimize the presence of harmful components (e.g., sulfur, carbon monoxide, etc.) in the hydrogen-rich gas exiting the fuel processor system. These extra exchangers/reactors usually have widely divergent physical characteristics and configurations, including but not limited to rectangular boxes and/or cylindrical cans. Not surprisingly, when attempting to integrate all of these various parts into a single, coherent fuel processor system, a bulky and/or otherwise inefficient unit (in terms of operation, weight and overall size) usually results.

In light of the foregoing, a reformer system that is compact, economical, light-weight, and that is easier to manufacture, would be welcome. Moreover, a reforming process apparatus, which is readily incorporated into a more complete fuel processing system and which is easy to adapt to any number of intended uses, is needed.

### SUMMARY OF THE INVENTION

The present invention solves the problems discussed above by providing a modular fuel processor system, which is readily adapted to meet the specific requirements of a variety of processes which require a hydrogen-rich gas. In particular, a single, integrated fuel processing unit is possible because the entire set of fuel processing operations have been adapted to match a unique reforming process apparatus which utilizes a specialized plate-type configuration.

In one embodiment the unit operations are separate modules, which plug into a backbone unit. The modules have unique plate designs for the individual processes but the same overall configuration. The modules clamp into the backbone. If operating temperatures are not too high, the modules provide quick disconnect connections to the piping connecting the modules. Where temperatures are too high for quick disconnect connections, the connections to the piping are welded. Fluid piping, controls and sensors can also all be connected to the backbone unit. The resulting system reduces the size of the system, while the modular structure makes maintenance and installation easier.

Two alternatives to this design implement a single tower system which is divided into halves to make the system more compact and adaptable. The two half stacks are positioned either side by side (creating a shorter overall tower arrangement) or back to back (allowing all the piping, controls and sensors to be shared by the stacks). Either of these half-stack units make for particularly useful configurations for many transportation-related applications.

In the second embodiment, further integration and compactness is achieved by combining all the unit operations into a single device, which would be configured like the heat exchanger shown in FIG. 6. A system of this type has all unit operations and fluid interconnects on the inside of the unit, with only external fluid connections on the outside.

In view of the foregoing it will be seen that one aspect of the present invention is to provide a fuel cell operational system integrated into a single unit.

Another aspect of the present invention is to provide a fuel cell operational system integrated into a single unit where all the functional units use reformer plate technology.

These and other aspects of the present invention will be more fully understood after a careful review of the following description of one preferred embodiment, taken and considered together with the accompanying drawings.

### BRIEF DESCRIPTION OF THE DRAWINGS

In the drawings:

FIG. 1 is a perspective view of a known heat exchanger using plate technology;

FIG. 2 is a perspective view of plates used in a prior art plate reformer;

FIG. 3 is a perspective view of the plates of FIG. 2 combined into a known plate reformer;

FIG. 4 is a schematic showing the various needed sub-systems separately set up for an operational fuel processing and fuel cell system;

FIG. 5 is a perspective view of the modular unitary construction of the fuel processing system of the present invention;

FIG. 6 is two alternate two-piece construction for the modular unitary construction for the fuel processing system of FIG. 5; and

FIG. 7 is a second alternate one-piece construction using reformer plate technology for the modular unitary construction for the fuel processing system of the present invention.

### DESCRIPTION OF THE PREFERRED EMBODIMENT

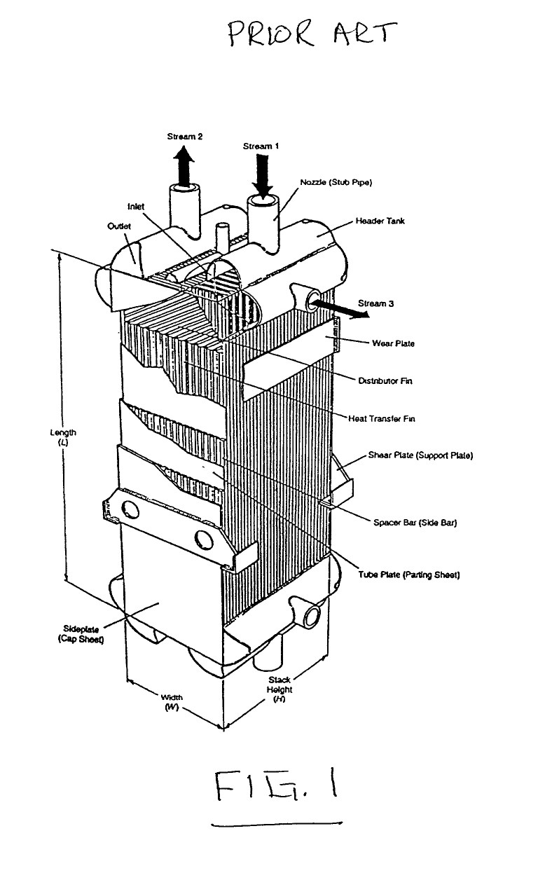

Referring generally to the drawings and particularly to FIG. 1, a plate reformer assembly is created as a variation of a known plate exchanger design. In the plate reformer design, a metal plate is provided and coated with a reforming catalyst on one side and a combustion catalyst on the opposite side. The plates are then stacked to create separate reforming and combustion channels, wherein the heat from combustion passes through the plate to drive the reforming reaction in the adjacent channels. This approach decreases the size of the reformer itself, while increasing efficiency in comparison to other non-plate based reformer designs.

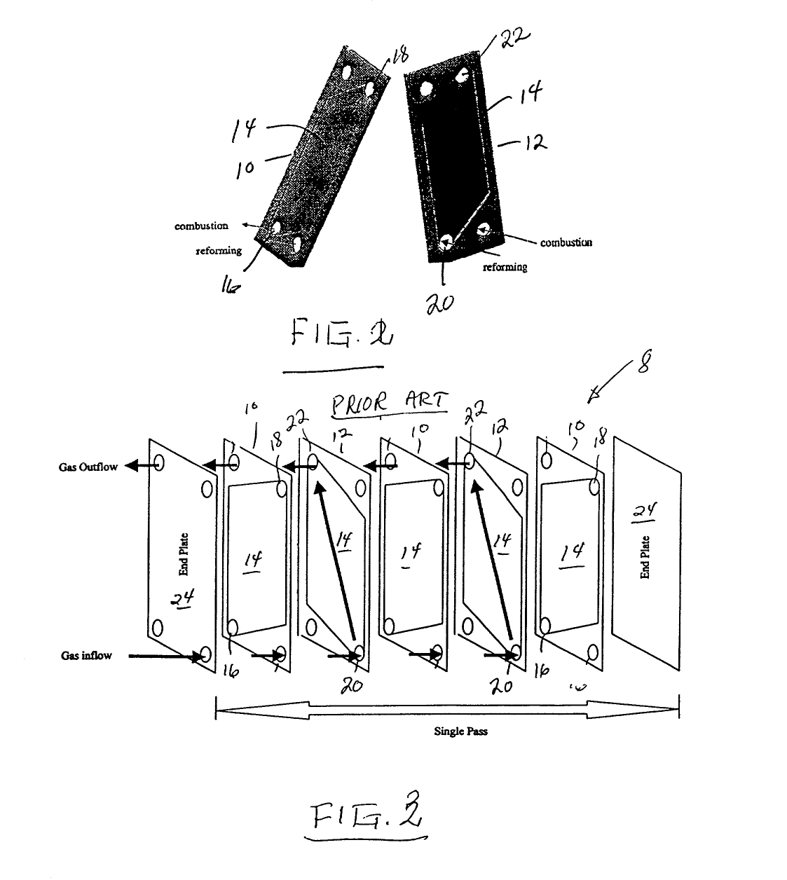

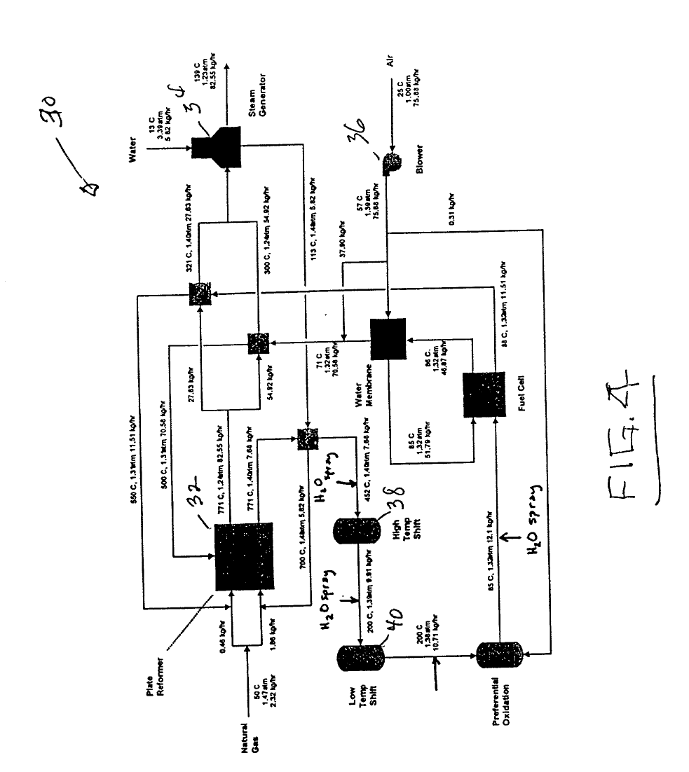

A plate for such an assembly is pictured in FIGS. 2 and 3. Assembly (8) consists of a series of plates (6), having a combustion side (10) and a reforming side (12). Preferably, these sides (10, 12) are coated with combustion and reforming catalyst(s), respectively. Such catalysts are well known to those skilled in the art, as are the methods of application and maintenance. By way of example, rather than limitation, an appropriate catalyst may be applied using a wash coating process on a thin catalyst support structure.

On each of these respective sides (10, 12), a hollow portion (14) is provided and connected to combustion inlet (16) and outlet (18), as well as reforming inlet (20) and outlet (22). As mentioned above, these plates (6) are then stacked as shown so that separate and distinct combustion and reforming channels are formed by the hollow portions (14) and the respective inlets (16, 20) and outlets (18, 22). This arrangement makes for a compact and thermally efficient reformer assembly.

As best illustrated in FIG. 3, the assembly may be sealed by end plates (24), thereby forming an entire reformer assembly “stack”. The resulting design creates a single-pass device wherein the reactant gases enter through an inlet manifold (not shown); are then distributed to the respective channels (discussed above); and finally exit through the outlet manifold (not shown).

However, as discussed above, a complete fuel processor system often times encompasses more than a simple reformer. Accordingly, a conceptual process flow diagram with the various fuel processor unit operations, and interrelated heating and cooling streams, for a system (30) is shown in FIG. 4. Preferrably, system (30) may be any type of fuel cell system, including but not limited to: PEM cells, solid oxide cells, and/or molten carbonate cells.

Reforming process apparatus (32), similar to that discussed and shown in FIG. 3, is only one element in system (30). Steam may be provided from any suitable source (34) and air from a blower (36) for the fuel mixture and the air mixture needed for any/all of the required processes. The processes contemplated include, but are not limited to, the following: fuel cell systems, water gas shift reactors, preferential or selective oxidation and other such discrete sub-systems, all of which use various known technologies and configurations.

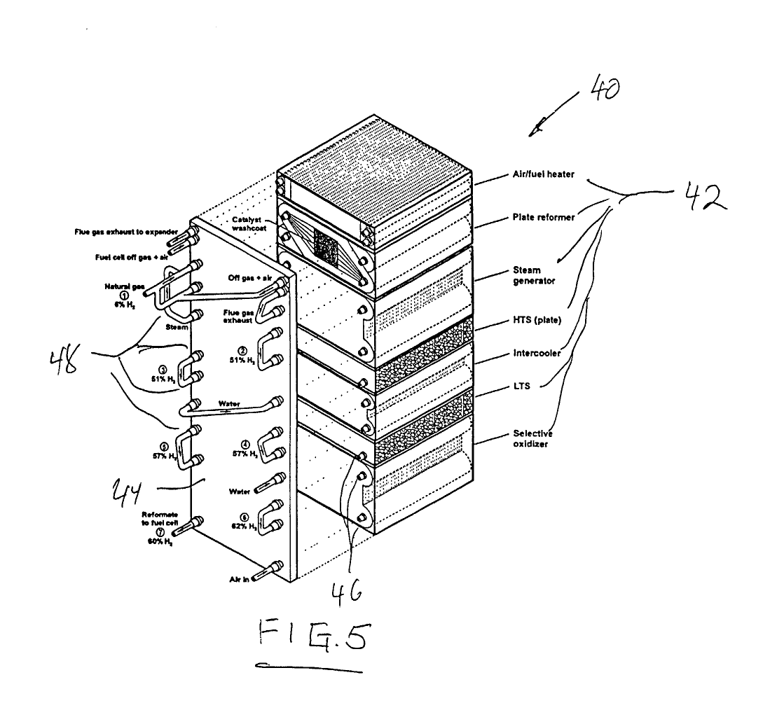

Referring particularly to FIG. 5, a single unit system (40) is shown having various modules (42) of the major operation units shown in FIG. 4, all of which plug into a backbone (44). The modules (42) contemplated herein are modified to have unique plate designs for the individual processes based on the plate reformer technology shown in FIG. 3 and discussed above. This common plate configuration allows all of the processes to be fitted together into the single unit system (40). The modules (42) clamp into the backbone. If operating temperatures are not too high, the modules are provide with the quick disconnect connections (46) to the piping (48) connecting the modules. Where temperatures are too high for quick disconnect connections, the connections to the piping may be welded. Fluid piping, controls and sensors (not shown) would also all be connected to the backbone (44). The modules (42) in the above embodiment make maintenance simple, in that each unit may thus be easily removed for inspection, cleaning and/or replacement without touching any other part of the system. The modules also help to simplify and reduce the cost of construction of the overall system.

The various modules (42) shown, such as the water-gas-high-temperature-shift reactor (HTS), low-temperature-shift (LTS) reactor and selective oxidation (Selox) reactor can have a known plate, bed or combined configuration. In the combined configuration, the space between the plates would be packed with catalyst. This precise arrangement of process units would result in better utilization of the catalyst over the single packed bed because of improved flow distribution and lower pressure drop. The combined plate/bed would also be more compact for the same reason.

It will thus be seen that the main advantages of this invention are reduced size and ease of construction and maintenance.

An alternative to this design is shown in FIG. 6 where the single modular system (40) is divided in two halves (40a, 40b) to make the system smaller. In FIG. 6a, the two half stacks are side-by-side making the system shorter. In FIG. 6b, the two half stacks are back-to-back with all the piping, controls and sensors in the center. This is a good configuration for transportation applications or other situations where size is a concern.

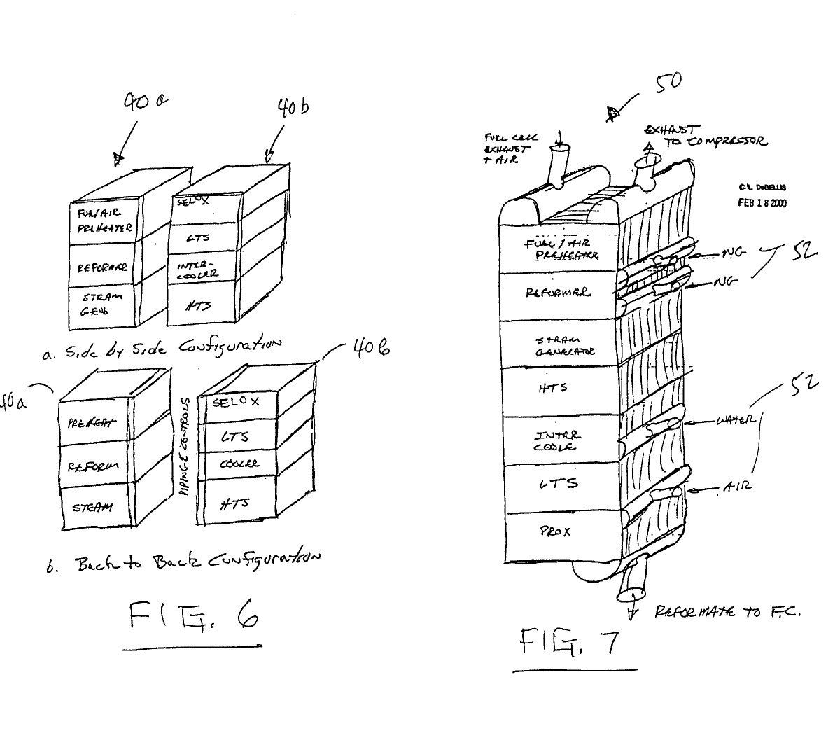

In yet another embodiment shown in FIG. 7, further integration and compactness is achieved by combining all the unit operations into a single system (50), which would be configured like the plate heat exchanger shown in FIG. 1. A system (50) of this type has all unit operations and fluid interconnects are on the inside of the unit (not shown), with only external fluid connections (52) on the outside.

It will be understood that certain additions and modification have been deleted herein for the sake of conciseness and readability since they would occur to those skilled in this art area. As an example, the simple flat plate reformer may require a large surface area to reform the fuel. One way to increase area without a proportional increase in size would be to add catalyst coated fins between the plates or corrugate the plate like standard plate heat exchangers. In addition, the fins or corrugations add strength. It will therefore be understood that all such are intended to fall within the scope of the following claims.

We claim:

1. A modular fuel processing system for providing hydrogen-rich gas comprising:
a backbone member; and
a series of fuel processing operation modules arranged in a stacked formation, each module having connection means for fluidically connecting the module to the backbone member and each module having an essentially rectangular shape with a top, a bottom, a connection facing, a non-connection facing and two side facings.

2. A fuel processing system as set forth in claim 1, wherein the series of modules consists of at least one of: a plate reformer module, a water-gas-shift reactor, a heat exchanger, a selective oxidation reactor and means for generating steam.

3. A fuel processing system as set forth in claim 1, wherein the series of modules are arranged in two separate stacks.

4. A fuel processing system as set forth in claim 3, wherein the backbone member is formed to connect the separate stacks in a side-by-side configuration with the side facing of each stack being closest to one another.

5. A fuel processing system as set forth in claim 4, wherein the modules of one stack include a fuel/air preheater, a reforming process unit, and means for generating steam and wherein the modules of the other stack include a selective oxidation reactor, a low-temperature water-gas-shift reactor, a heat exchanger and a high-temperature water-gas-shift reactor.

6. A fuel processing system as set forth in claim 5, wherein the modules of each stack are arranged from top to bottom in the order recited herein.

7. A fuel processing system as set forth in claim 3, wherein the backbone member is formed to connect the separate stacks in a back-to-back configuration with the connection facing of each stack being closest to one another.

8. A fuel processing system as set forth in claim 7, wherein the modules of one stack include a fuel/air preheater, a reforming process unit, and means for generating steam and wherein the modules of the other stack include a selective oxidation reactor, a low-temperature water-gas-shift reactor, a heat exchanger and a high-temperature water-gas-shift reactor.

9. A fuel processing system as set forth in claim 8, wherein the modules of each stack are arranged from top to bottom in the order recited herein.

10. A fuel processing system as set forth in claim 2, wherein the modules are arranged from top to bottom in the following order: a fuel/air preheater, a reforming process unit, means for generating steam, a high-temperature water-gas-shift reactor, a heat exchanger, a low-temperature water-gas-shift reactor and a selective oxidation reactor.

11. A fuel processing system as set forth in claim 10, wherein each module has a plate reactor configuration.

12. A fuel processing system as set forth in claim 1, wherein each module has a plate reactor configuration.
